(19) United States
(12) Patent Application Publication
(10) Pub. No.: US 2002/0158875 A1
(43) Pub. Date: Oct. 31, 2002

(54) Method, apparatus, and program for displaying images

(75) Inventor: Masahiko Yamada, Kaisei-machi (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/124,327

(22) Filed: Apr. 18, 2002

(30) Foreign Application Priority Data
Apr. 26, 2001 (JP) 128642/2001

(51) Int. Cl. G06T 11/20

(52) U.S. Cl. 345/440

(57) ABSTRACT

The explanation of the results of a diagnosis becomes easier to perform while an image is displayed on a monitor. A table recording a variety of diagnostic findings, and image processing parameters corresponding thereto is stored in a storage means. When the diagnostic findings are inputted from an input means, an image processing means obtains, based on the table, the image processing parameter according to the diagnostic results. Then, the image processing means subjects the medical data to image processes, by use of the image processing parameter, to obtain processed image data, which is then displayed as a visible image on the monitor.

### BACKGROUND OF THE INVENTION

1. Field of the Invention

The present invention relates to an image display method and apparatus for displaying medical images on a monitor, and a program for causing a computer to execute said image display method.

2. Description of the Related Art

There are in use in the field of medicine today systems for storing, on an image server in a hospital, a plurality of image data representing radiation images obtained of patients and, in response to a request from a terminal connected to the image server via a network, transmitting image data to the terminal. According to systems of this type, the image data obtained by the photographing of patients by use of an input modality such as a CR (Computed Radiography) apparatus, a CT (Computerized Tomography) apparatus, an MRI (Medical Resonance Imagery) apparatus, etc., is compiled for each patient as well as for each examination and stored in the image server. At this time, the image data is subjected to image processes such as a frequency enhancement process, a gradation process, a dynamic range compression process, etc. Alternatively, an image processing parameter for performing said image process can be attached to the image data. Then, a physician transmits the image data of a patient to said physician's personal terminal from the image server, subjects the image data to image processes by use of the image processing parameter, as required, and displays the image for observation and diagnosis.

On the other hand, an energy subtraction process for obtaining an image that represents the difference between a plurality of medical images, each being obtained under mutually different photographing conditions, is also in use. This energy subtraction process, more specifically, is a process wherein by correlating the pixels between different images and performing a subtraction process therebetween, an enhanced or extracted image of a target subject portion can be obtained.

Further, in order to confirm the effectiveness of treatment or progression of a disease, the pixels of an image obtained in the present examination are correlated to the pixels of an image obtained in a previous examination and a subtraction process is performed therebetween, whereby the so-called temporal subtraction process, in which the difference between the medical images is extracted, is also carried out. By extracting only the interimage difference in this manner, because the difference between the images can be recognized with accuracy by a person performing a diagnostic reading thereof, the overlooking of the treatment or the progression of the disease at the diseased tissue can be prevented.

According to systems of the type described above, after the image data obtained by the input modality (including image data obtained by performing an energy subtraction process or a temporal subtraction process) has been stored in the image server, a diagnostic reading thereof is performed by a radiologist specializing in diagnostic reading. The performance of this diagnostic reading consists of the radiologist displaying the image to be diagnosed on said radiologists personal terminal, observing the displayed image, diagnosing the scope of the disease, the degree of the progression of the primary nidus, etc., and drafting a written diagnostic report and/or an electronic chart. Note that the electronic chart drafted by the radiologist is correlated to the diagnosed image data and stored in the image server.

On the other hand, the results of the diagnosis are explained to the patient by a clinical internalist or surgeon. In this case, the clinician displays the image data on said clinician's personal terminal, and explains the name and course of the disease, the degree of the progression of the primary nidus, the method of treatment, etc., while referencing the diagnostic report and/or the electronic chart.

However, because the patient receiving the explanation of the diagnosis does not know what an image of a normal tissue looks like, even if shown the image including the diseased tissue, the patient cannot readily discern which portion of the image is abnormal. Further, although the abnormal portion of the image including the diseased tissue has been compared to the other portions of the image and the signal value there of changed slightly, it is difficult for the patient to discern the change in said signal as a change in the density of the image. Also, because the abnormal portion of the image is often very small, it is difficult to find within the image.

Therefore, subjecting the image data to image processes rendering the abnormal portion of the image including the diseased portion readily discernable to the patient has been considered. However, because a clinician is not an image processing specialist, the subjection of the image to the optimal image processes for rendering the abnormal portion of the image readily discernable to the patient is difficult. Further, because the operation of subjecting the image data to this type of optimal image processes constitutes a new burden on the clinician, it is disadvantageous.

### SUMMARY OF THE INVENTION

The present invention has been developed in view of the circumstances described above, and it is a primary object of the present invention to facilitate the explanation of the results of a diagnosis in a manner that is easy for the patient to understand, and easy for the explainer to perform.

The first image display method according to the present invention comprises the steps of: subjecting medical image data to an image process to obtain processed image data; and displaying the processed medical image represented by said processed image data on a monitor; wherein

input of medical explanatory data related to the medical image represented by the medical image data is received; and

said medical image data is subjected to an image process by use of an image processing parameter corresponding to the medical explanatory data.

The referents of “image process” more specifically, include frequency enhancement processes, magnification processes, density conversion processes, etc.

The phrase “image processing parameter” refers to the parameter required when the image data is to be subjected to a gradation process, a frequency enhancement process, a dynamic range compression process, magnification processes, density conversion processes, etc. More specifically, the slope of the gradation conversion curve occurring in the gradation process, the enhancement coefficient representing the degree of frequency enhancement occurring in the frequency enhancement process, the coefficient representing the degree of compression occurring in the dynamic range compression process, the magnification rate of the magnification process, the coefficient representing the quantity of density conversion occurring in the density conversion process, etc., can be employed as the image processing parameter.

As to the “monitor”, a CRT display, an LCD display, a plasma display or the like, in short, any device capable of displaying an image can be employed thereas.

The referents of “medical explanatory data” include data representing the examination method, the diagnostic findings, the name of the disease, the degree of seriousness of the disease (light or heavy), the photographed portion, the photographing method and/or the degree of progression of the disease, etc.

Note that the input of the medical explanatory data can be received from a keyboard or a mouse, and for cases in which an electronic chart has been drafted, the medical explanatory data stored on the electronic chart may be obtained.

The phrase “an image processing parameter corresponding to the medical explanatory data” refers to a parameter capable of causing the image data to be subjected to an image process so that the results of the examination can be easily explained to and understood by the patient; more specifically, to a parameter capable of causing image processing that enhances the minute signal change occurring in the portion of the image representing the diseased portion.

The second image display method according to the present invention comprises the steps of: subjecting medical image data to image processes to obtain processed image data; and displaying the processed medical image represented by said processed image data on a monitor; wherein

input of medical explanatory data related to the medical image represented by the medical image data is received; and

said medical image data is subjected to a plurality of types of image processes by use of an image processing parameter for a plurality of types of image processes corresponding to the medical explanatory data.

The third image display method according to the present invention comprises the steps of: subjecting medical image data to image processes to obtain processed image data; and displaying the processed medical image represented by said processed image data on a monitor; wherein

the input of the diagnostic findings and the diagnostic region, of which the diagnostic findings have been obtained, within the medical image represented by the medical image data are received, and

the image processes are performed based on the region data and the diagnostic findings representing the diagnostic region.

Here, when performing diagnostic reading of a normal medical image, the diseased portion is observed and the diagnostic findings are drafted. Accordingly, the phrase “diagnostic region” refers to the region of a specified range within a medical image including a diseased portion of which a diagnosis has been obtained. Note that data determining the diagnostic range (such as the coordinates of four corners for a case in which the diagnostic range is a rectangle) can be included in the diagnostic findings drafted when the electronic chart is drafted. In this case, by receiving the input of the diagnostic findings, the input of both the diagnostic findings and the diagnostic range can be received at the same time.

Note that the “image process” occurring in the third image display method according to the present invention is an image process enabling the diagnostic results of the diagnostic region to be easily explained to and understood by the patient, and may be an image process to be performed only on the diagnostic region, or an image process to be performed on the entirety of the medical image data.

The fourth image display method according to the present invention comprises the steps of: displaying the medical image represented by the medical image data on a monitor; wherein

input of medical explanatory data related to the medical image represented by the medical image data is received; and

the display or non-display of at least one reference image relating to said medical image, corresponding to said medical explanatory data and is switched between.

The referents of “reference image” include types of images to be referred to when the medical image is displayed and an explanation of the diagnosis is being provided to the patient, wherein by referring to the reference image the explanation of the results of the diagnosis of the medical image to the patient becomes easier. In the case, for example, in which previous medical image data is used to perform a temporal subtraction process, the temporal subtraction image and the previous medical image can be employed as reference images.

Note that for cases in which the explanation of the results of a diagnosis can be performed easily without using reference images, because the medical image can be displayed on the monitor as a larger image if no reference images are displayed thereon, the performance of the explanation to the patient can be made easier. The fourth image display method according to the present invention has been provided with a function for switching between the display and non-display of reference images in order to facilitate these types of cases in which reference images are not to be displayed.

The fifth image processing method according to the present invention comprises the steps of: displaying the plurality of medical images represented by a plurality of medical image data on a monitor in a predetermined display order and/or a predetermined layout; wherein

input of medical explanatory data related to the plurality of medical images is received; and

the predetermined order and/or a predetermined layout is set corresponding to said medical explanatory data.

The referents of “predetermined order and/or a predetermined layout” include a display order in which medical images can be displayed and/or a layout in which a plurality of medical images can be displayed in order that the performance of explanation of the results of the diagnosis of the medical image to the patient can be made easier.

The sixth image display method according to the present invention comprises the steps of: displaying the medical image represented by the medical image data on a monitor; wherein

based on the medical explanatory data related to the medical image, a normal image including the portions corresponding to the abnormal portions included within the medical image is selected from a storage means, which has recorded therein a plurality of normal images for a variety of portions, and

said corresponding normal image is displayed together with the medical image.

The referent of “normal image is displayed together with the medical image” can be that the normal image and the medical image are displayed next to each other, or that the display of the normal image and the medical image are switched sequentially.

The first image display apparatus according to the present invention is an apparatus for subjecting medical image data to an image process to obtain processed image data and displaying the processed medical image represented by said processed image data on a monitor, and comprises

an input means for receiving the input of medical explanatory data related to the medical image represented by the medical image data; and

an image processing means for subjecting said medical image data to an image process by use of an image processing parameter corresponding to the medical explanatory data.

The second image display apparatus according to the present invention is an apparatus for subjecting medical image data to image processes to obtain processed image data and displaying the processed medical image represented by said processed image data on a monitor, and comprises

an input means for receiving the input of medical explanatory data related to the medical image represented by the medical image data; and.

an image processing means for subjecting said medical image data to a plurality of image processes by use of image processing parameters for a plurality of image processes corresponding to the medical explanatory data.

The third image display apparatus according to the present invention is an apparatus for subjecting medical image data to image processes to obtain processed image data and displaying the processed medical image represented by said processed image data on a monitor, and comprises

an input means for receiving the input of a diagnostic findings, and the diagnostic region of which the diagnostic findings have been obtained within the medical image represented by the medical image data, and

an image processing means for subjecting, based on the region data and the diagnostic findings representing the diagnostic region, the medical image data to image processes.

The fourth image display apparatus according to the present invention is an apparatus for displaying on a monitor the medical image represented by the medical image data, and comprises

an input means for receiving the input of medical explanatory data related to the medical image represented by the medical image data; and

an image switching means for switching between the display and non-display of at least one reference image relating to said medical image, corresponding to said medical explanatory data.

The fifth image processing apparatus according to the present invention is an apparatus for displaying a plurality of medical images represented by a plurality of medical image data on a monitor in a predetermined order and/or a predetermined layout, and comprises

an input means for receiving input of medical explanatory data related to the plurality of medical images; and

a layout setting means for setting the predetermined order and/or a predetermined layout corresponding to said medical explanatory data.

The sixth image display apparatus according to the present invention is an apparatus for displaying the medical image represented by the medical image data on a monitor, and comprises

a storage means for recording, based on the medical explanatory data related to the medical image, a plurality of normal images for various portions,

a selecting means for selecting from the storage means a normal image including portions corresponding to the abnormal portions included within the medical image, and

a display means for displaying said corresponding normal image is displayed together with the medical image.

Note that the image display method according to the present invention may be provided as a program for causing a computer to execute said method.

According to the first image processing method and apparatus of the present invention, medical image data is subjected, by use of an image processing parameter, to an image process corresponding to the medical explanatory data related thereto. Further, according to the second image processing method and apparatus of the present invention, medical image data is subjected, by use of image processing parameters, to a plurality of image processes corresponding to the medical explanatory data related thereto. Therefore, processed image data that can be reproduced and which enables the explanation of the results of the diagnosis to be provided to the patient with ease can be obtained. Also, the necessity that a clinician providing an explanation of the results of a diagnosis to a patient possess specialized knowledge relating to image processing is eliminated, whereby the workload on the clinician can be reduced.

According to the third image processing method and apparatus of the present invention, medical image data is subjected to image processes based on the medical data within the diagnostic region and the diagnostic findings. Therefore, image processes can be performed that enable the results of a diagnosis to be explained to the patient with ease by use of the image of the diagnostic region of which the diagnosis and diagnostic remarks have been obtained; in this manner, it becomes possible for the patient to readily recognize the results of the diagnosis. Also, the necessity that a clinician providing an explanation of the results of a diagnosis to a patient posses specialized knowledge relating to image processing is eliminated, whereby the workload on the clinician can be reduced.

According to the fourth image processing method and apparatus of the present invention, the display and non-display of at least one reference image is switched between, corresponding to the medical explanatory data. Accordingly, because a reference image can be displayed for cases in which the employment thereof facilitates ease of explanation of the results of a diagnosis to the patient, the explanation of the results of a diagnosis to the patient can be performed easily. On the other hand, for cases in which the explanation of the results of a diagnosis to the patient can be performed with ease without employing reference images, a reference image is not displayed. Accordingly, the medical image can be displayed on the monitor as a larger image, and the trouble in switching the display screen or displaying images on a plurality of monitors can be saved.

According to the fifth image processing method and apparatus of the present invention, the display order and/or layout of a plurality of medical images is set corresponding to the medical explanatory data related thereto. Therefore, a display order and/or layout facilitating ease of explanation of the results of a diagnosis to the patient can be set, whereby the physician can easily provide an explanation of the results of a diagnosis to the patient.

According to the sixth image processing method and apparatus of the present invention, a medical image including an abnormal position and a corresponding normal image are displayed. Therefore, the patient can easily compare the abnormal portion to the normal portion, and the physician can easily perform explain the results of a diagnosis to the patient.

### BRIEF DESCRIPTION OF THE DRAWINGS

FIG. 1 is a block diagram of the first embodiment of the image display apparatus according to the present invention,

FIG. 2 is a flow chart showing the operation of the first embodiment,

FIG. 3 is a block diagram of the second embodiment of the image display apparatus according to the present invention,

FIG. 4 is a flow chart showing the operation of the second embodiment,

FIG. 5 is a block diagram of the third embodiment of the image display apparatus according to the present invention,

FIG. 6 is a flow chart showing the operation of the third embodiment,

FIG. 7 is a block diagram of the fourth embodiment of the image display apparatus according to the present invention,

FIG. 8 is a flow chart showing the operation of the fourth embodiment,

FIG. 9 is a drawing illustrating an image in the display state thereof on the monitor (one such display state),

FIG. 10 is a drawing illustrating an image in the display state thereof on the monitor (a second such display state),

FIG. 11 is a block diagram of the fifth embodiment of the image display apparatus according to the present invention,

FIG. 12 is a drawing illustrating an example of the image display layout,

FIG. 13 is a flow chart showing the operation of the fifth embodiment,

FIG. 14 is a block diagram of the sixth embodiment of the image display apparatus according to the present invention, and

FIG. 15 is a flow chart showing the operation of the sixth embodiment.

### DESCRIPTION OF THE PREFERRED EMBODIMENTS

Hereinafter, the preferred embodiments of the present invention will be explained with reference to the attached drawings.

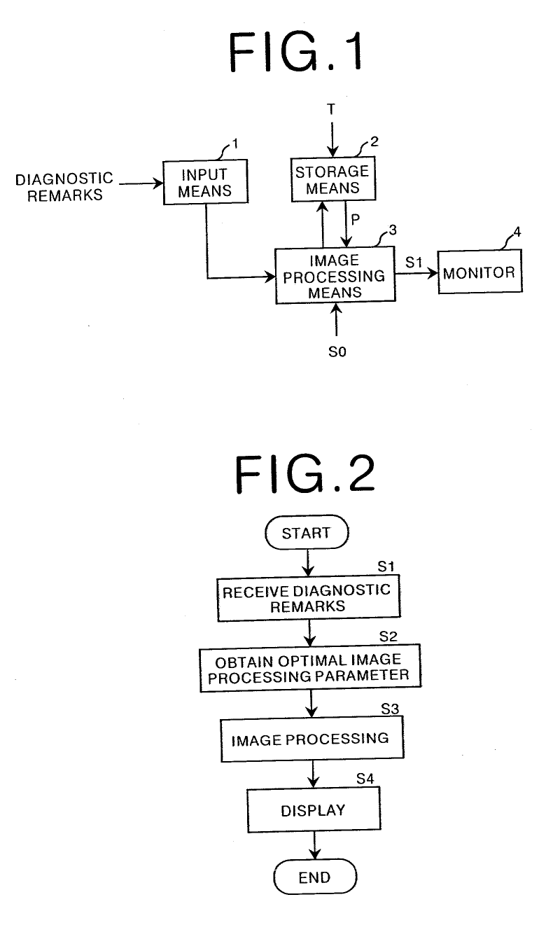

FIG. 1 is a block diagram of the first embodiment of the image processing apparatus according to the present invention. As shown in FIG. 1, the image display apparatus according to the first embodiment of the present invention comprises: an input means 1 for receiving the diagnostic findings representing the results of the diagnosis of an image data S0; a storage means 2 for recording a table T in which a variety of diagnostic findings have been correlated to image processing parameters P; an image processing means 3 for referring to the table T and performing, as described below, an image process on the image data S0 to obtain an image data S1; and a monitor 4.

The image data S0 can be an image data stored in an image data base (not shown), or an image data recorded on a storage medium.

The input means 1 can be a manually operated input means such as a keyboard or a mouse for manually inputting the diagnostic findings contained within the diagnostic report or the electronic chart, or a means for reading out the diagnostic findings contained within the diagnostic report or the electronic chart stored in the image data base (not shown) or recorded on a media, and inputting the read out diagnostic findings to the image processing means 3.

According to the current embodiment, the table T recorded in the storage means 2 is a table wherein the diagnostic findings of the representative symptoms of diseases afflicting the thorax, such as interstitial disease, lung cancer, tuberculosis, pneumonia, emphysema, etc., have been correlated to an image parameters P (hereinafter referred to as an optimal image processing parameter) for performing an image process on the image data S0 so that the explanation of the diagnosis to the patient can be performed with ease.

The image processing means 3 is a means for referring, based on the diagnostic findings inputted at the input means 1, to the table T recorded on the storage medium 2 and obtaining the optimal image processing parameter P for the image data S0, and subjecting the image data S0 to an image process, by use of the obtained optimal image parameter P, to obtain a processed image data S1. Note that according to the first embodiment, the image processing means 3 performs a single image process on the image data S0.

Here, for an image in which symptoms of interstitial disease, lung cancer, tuberculosis, pneumonia, emphysema, etc., appear, and an image in which no symptoms of any disease appear, it has been discerned by the results of evaluation by a radiologist that the image processing parameter that yields an image in which the disease is readily discerned is different for “faint humectation shadows”, “tubercular shadows”, “reticular shadows”, and “granular shadows”. For example, for a case in which the image process to be performed is a frequency enhancement process, it is known that: it is preferable that the degree of frequency enhancement is weak if the evaluation is “faint humectation shadows”; it is preferable that the degree of frequency enhancement is strong if the evaluation is “tubercular shadows”, “reticular shadows”, or granular shadows”, (hereinafter referred to as tubercular shadows or the like) Further, for a case in which the image process to be performed is a gradation process, it is known that it is preferable that a high contrast image is obtained for “faint humectation shadows”, and that a lower contrast image is obtained for “tubercular shadows or the like”.

Accordingly, for a case in which the image process to be performed is a frequency enhancement process, if the evaluation is “faint humectation shadows”, the image processing parameter P is correlated thereto in the table T so that the degree of the frequency enhancement is not too strong or does not enhance the frequency at all; if the evaluation is “tubercular shadows or the like”, the image processing parameter P is correlated thereto so that the degree of the frequency enhancement is strong.

Further, if the image process to be performed is a gradation process and the evaluation is “faint humectation shadows”, the image processing parameter P is correlated thereto in the table T that causes high contrast image, and if the evaluation is “tubercular shadows or the like”, an image parameter P that causes a low contrast is correlated thereto.

The monitor 4 can be a CRT monitor, an LCD monitor, a plasma display, or other device that displays an image on a display screen.

Next, the operation of the first embodiment will be explained. FIG. 2 is a flow chart showing the operation of the first embodiment. First, the input of the diagnostic findings is received (step S1), and then the table T recorded on the storage medium 2 is referred to and the optimal image processing parameter P is obtained, based on the inputted diagnostic findings (step S2). Continuing, the image data S0 is subjected, by use of the obtained optimal image processing parameter P, to an image process to obtain a processed image data S1 (step S3). Then, the image represented by the processed image data S1 is displayed on the monitor 4 (step S4), to be provided for use in the explanation of the diagnosis to the patient.

In this manner, according to the first embodiment, because the image data S0 is subjected to an image process by use of the optimal image processing parameter P according to the diagnostic findings, a reproducible processed image data S1, which enables the results of the diagnosis to be explained to the patient with ease, can be obtained, and if the processed image is referred to, the patient can easily recognize the results of the diagnosis. Further, the necessity that a clinician providing an explanation of the results of a diagnosis to a patient possess specialized knowledge relating to image processing is eliminated, whereby the burden on the clinician can be reduced.

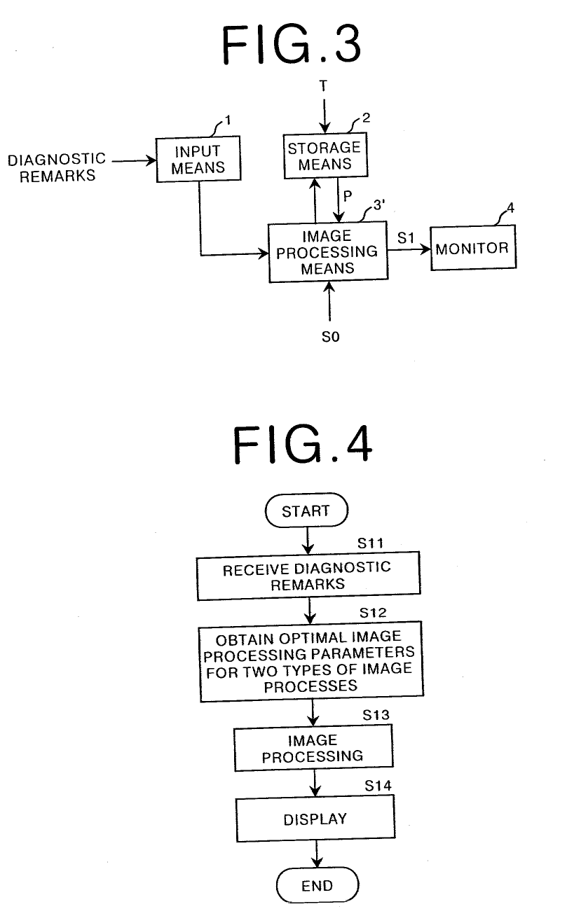

Next, the second embodiment of the present invention will be explained. FIG. 3 is a block diagram of the second embodiment of the image display apparatus according to the present invention. Note that elements of the second embodiment shared in common with the first embodiment are likewise labeled, and in so far as it is not particularly required, further explanation thereof is omitted. The second embodiment differs from the first embodiment in that the second embodiment is provided with an image processing means 3′ for performing two types of image processes on the image data S0.

Note that according to the second embodiment, each diagnostic finding is correlated in the table T to a combination of two types of image processes as well as an image processing parameter P for each of the two types of image processes. Here, the combination of two types of image processes can be a frequency enhancement process and a gradation process, a frequency enhancement process and a dynamic range compression process, a dynamic range compression process and a gradation process; an image processing parameter P for each combination is recorded in the table T recorded on the storage medium 2.

Next, the operation of the second embodiment will be explained. FIG. 4 is a flow chart showing the operation of the second embodiment. First, the input of the diagnostic findings is received (step S11), and then the table T recorded on the storage medium 2 is referred to and the combination of two types of image processes as well as the optimal image processing parameters P for said combination of two types of image processes is obtained, based on the inputted diagnostic findings (step S12). Continuing, the image data S0 is subjected, by use of the obtained optimal image processing parameters P, to two types of image processes to obtain a processed image data S1 (step S13). Then, the image represented by the processed image data S1 is displayed on the monitor 4 (step S14), to be provided for use in the explanation of the diagnosis to the patient.

In this manner, according to the second embodiment, because the image data S0 is subjected to two types of image processes according to the diagnostic findings by use of the optimal image processing parameters P for a combination of two types of image processes, a reproducible processed image data S1, which enables the results of the diagnosis to be explained to the patient with ease, can be obtained, and if the processed image is referred to, the patient can easily recognize the results of the diagnosis. Further, the necessity that a clinician providing an explanation of the results of a diagnosis to a patient possess specialized knowledge relating to image processing is eliminated, whereby the burden on the clinician can be reduced.

Note that according to the second embodiment, although the image data S0 has been subjected to two types of image processes in the explanation provided above, the image data S0 can be subjected to three or more types of image processes.

Further, according to the first and second embodiments, there are cases in which a plurality of diagnostic findings are input for a single image data S0. In this type of case, an image parameter P can be obtained based on each of the received diagnostic findings and the image data S0 subjected to the image processes, whereby a processed image data S1 is obtained for each input diagnostic finding. Then, the image represented by each of the obtained processed image data S1 is displayed on the monitor 4. At this time, the images obtained for each processed image data S1 can be lined up next to each other and displayed concurrently, or sequentially switched and displayed one at a time.

Still further, according to the first and second embodiments, although in the explanation provided above the image processes have been performed by use of an image processing parameter P corresponding to the diagnostic findings, employing the table T in which the diagnostic findings and the image processing parameters have been correlated, a table T in which the image processing parameters have been correlated to medical explanatory data including the examination method, the diagnostic findings, the name of the disease, the degree of severity of the disease (light or heavy), the photographed portion, the photographing method and/or rate of the progression of the disease, or the like, can be employed. In this case, the input means 1 can receive the input of the medical explanatory data, the table T referred to, and the optimal image processing parameter P obtained therefrom based on the inputted medical explanatory data.

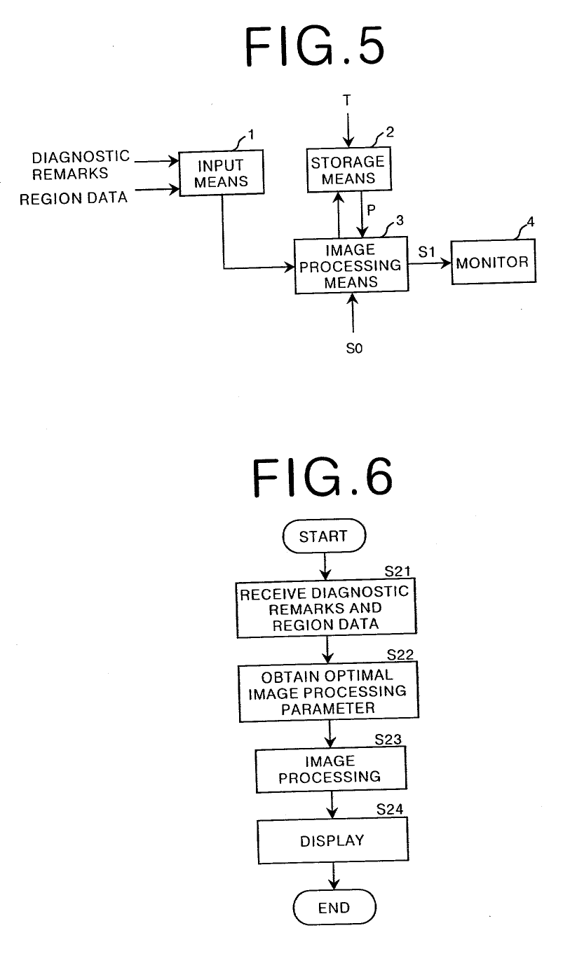

Next, the third embodiment of the present invention will be explained. FIG. 5 is a block diagram of the third embodiment of the image display apparatus according to the present invention. Note that elements of the third embodiment shared in common with the first embodiment are likewise labeled, and in so far as it is not particularly required, further explanation thereof is omitted. The third embodiment differs from the first embodiment in that the image data representing the region within the image represented by the image data S0 including the diseased portion of which the diagnostic findings have been obtained (hereinafter referred to as the diagnostic region) is input thereto, and image processes corresponding to the diagnostic region and the diagnostic findings are performed on the image data S0.

Note that according to the third embodiment, the table T recorded in the storage medium 2 is a table in which the diagnostic findings and the diagnostic region are correlated with the optimal image processing parameter P for subjecting the image data S0 to image processes.

Here, the optimal image processing parameter P for subjecting the image data S0 to image processes so that the diagnosis can be explained to the patient with ease is different for cases in which shadows of tumors are present within the field of the lungs in a medical image of the thorax, and for cases in which shadows of tumors are present within the field of the mediastinum. That is to say, in regard to the lung field and the mediastinal field, because the quantity of radiation passing therethrough, respectively, differs at the time of photographing, if the contrast of the lung field is optimized, the mediastinal field becomes saturated in high brightness, whereby it becomes difficult to recognize the contents of the mediastinal field. Therefore, according to the third embodiment: a table T, in which the diagnostic findings and the diagnostic region are correlated with the optimal image processing parameter P, is recorded in the storage medium 2; this table T is referred to and the image data S0 is subjected to image processes by use of the optimal image processing parameter P for subjecting the image data S0 to image processes.

Note that, in a case in which the diagnostic region is of a rectangular shape, for example, the region data representing the diagnostic region can be the coordinate data of the four corners thereof, and can be received by use of the input means 1. Further, because there are many cases in which the distribution of the signal value of the image data S0 differs, corresponding to the diagnostic region, for cases in which a key word, such as “lung field” or “mediastinum”, representing the diagnostic region is included in the diagnostic findings received by the input means 1, the regional data representing the diagnostic region can be obtained from the diagnostic findings.

Next, the operation of the third embodiment will be explained. FIG. 6 is a flow chart showing the operation of the third embodiment. First, the input of the diagnostic findings and the region data is received (step S21), and then the table T recorded on the storage medium 2 is referred to and the optimal image processing parameter P corresponding to the diagnostic findings and the region data is obtained, based on the inputted diagnostic findings and region data (step S22). Continuing, the image data S0 is subjected, by use of the obtained optimal image processing parameter P, to an image process to obtain a processed image data S1 (step S23). Then, the image represented by the processed image data S1 is displayed on the monitor 4 (step S24), to be provided for use in the explanation of the diagnosis to the patient.

In this manner, according to the third embodiment, because the image data S0 is subjected to image processes based on the diagnostic findings and the regional data representing the diagnostic region, the image within the diagnostic region of which the diagnostic findings have been obtained can be subjected to image processes so that the explanation of the results of the diagnosis can be provided to the patient with ease, whereby the patient can easily recognize the results of the diagnosis. Further, the necessity that a clinician providing an explanation of the results of a diagnosis to a patient possess specialized knowledge relating to image processing is eliminated, whereby the burden on the clinician can be reduced.

Note that according to the third embodiment, although in the explanation provided above the image data S0 has been subjected to the image processes, only the image data within the diagnostic region may be subjected to the image processes.

Further, according to the third embodiment, the image within the diagnostic region can be subjected to an image process that magnifies said diagnostic region (i.e., a magnification process) Here, as to the magnification process, various methods, such as a linear interpolation computation, a spline or other high order interpolation computation, a process that enhances the sharpness of the edge portions, an interpolation computation that enhances the smoothness of the flat portions (refer to Japanese Unexamined Patent Publication No. 9(1997)-32198, etc.), can be employed. Note that the magnification ratio can be determined according to the diagnostic findings.

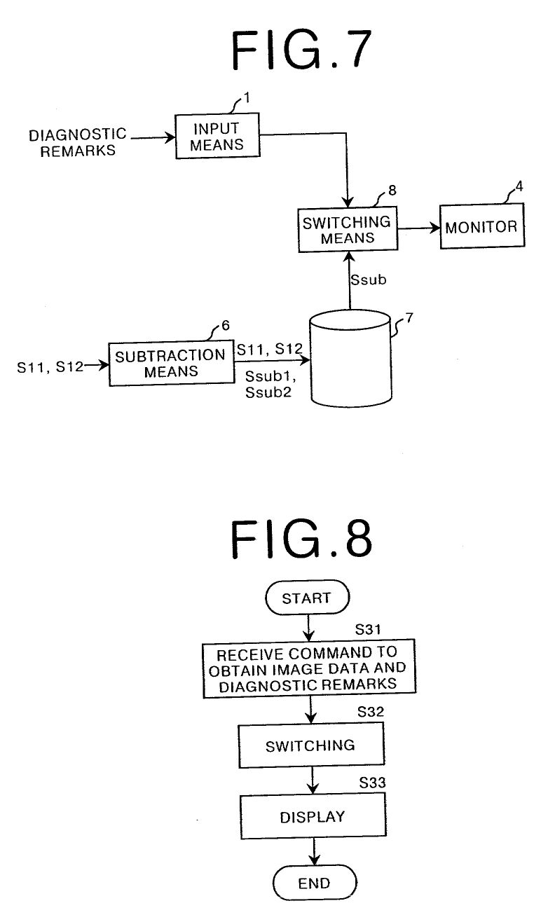

Next, the fourth embodiment of the present invention will be explained. FIG. 7 is a block diagram of the fourth embodiment of the image display apparatus according to the present invention. Note that elements of the fourth embodiment shared in common with the first embodiment are likewise labeled, and in so far as it is not particularly required, further explanation thereof is omitted. The fourth embodiment differs from the first embodiment in that: a subtraction means 6 obtains a subtraction image data Ssub representing the subtraction image between an image data S11 and an image data S12; the image data S11, S12 and the subtraction image data Ssub are stored in a data base 7; and a switching means 8 switches between the display and non-display of a reference image (here, the image represented by the subtraction image), which is an image other than the images displayed on the monitor 4, corresponding to the diagnostic findings inputted at the input means 1.

The subtraction means 6 performs an energy subtraction process or a temporal subtraction process. Here, for cases in which an energy subtraction process is performed, the image data S11 and S12 are obtained by irradiating the subject of photographing with radiations each having different respective energy levels. Then, an energy subtraction process is performed between the corresponding pixels between the images represented by the image data S11 and S12 to obtain a subtraction image data Ssub. Note that for cases in which an energy subtraction process is carried out, two subtraction images are obtained: a subtraction image Ssub 1 of the bone tissue, which represents the bone tissue included within the subject of photography; and a subtraction image Ssub 2 of the soft tissue, which represents the soft tissue included within the subject of photography.

On the other hand, for cases in which a temporal subtraction process is performed, each of image data S11 and S12 represent an image obtained in a past examination and an image obtained in the most recent examination, respectively. Then, a temporal subtraction process, wherein a subtraction process between the corresponding pixels between the images represented by the image data S11 and S12, is performed to obtain a subtraction image data Ssub.

Here, for cases in which an energy subtraction process has been performed by the subtraction means 6, in general, both a soft tissue image and a bone tissue image other than those represented by either of image data S11 and S12 are obtained as reference images from the data base 7 and displayed on the monitor 4; however, for cases in which the diagnostic findings inputted to the input means 1 include “calcification”, even if a soft tissue image is displayed, it is difficult to specify the calcified portions. Accordingly, for cases in which the diagnostic findings inputted to the input means 1 include “calcification” the switching means 8 obtains only one or the other of the images represented by the image data S11 and S12 and a subtraction image Ssub 1 representing the bone tissue thereof and displays said images on the monitor 4 without having obtained a subtraction image Ssub 2 representing the soft tissue.

Here, for cases in which the radiation image data representing the subject of photographing is stored on a stimulable phosphor sheet and a stimulated emission is caused to be emitted therefrom upon the irradiation thereof by an excitation light, whereby image data is obtained by photoelectrically converting this stimulated emission, as to the mode for obtaining two image data S11 and S12 to be subjected to an energy subtraction process, a plate formed of copper or other material that absorbs energy is disposed between two stimulable phosphor sheets, and there are two methods for obtaining the two image data S11 and S12: a one-shot method of irradiating both of the two stimulable phosphor sheets at one time with the radiation that has passed through the subject of photographing (refer to Japanese Unexamined Patent Publication No. 59(1983)-83486); and a two-shot method of irradiating the stimulable phosphor sheets with a high-energy radiation and a low-energy the radiation, respectively, that have passed through the subject of photographing (refer to Japanese Unexamined Patent Publication No. 60(1985)-22554). According to the current embodiment: for cases in which the image data S11 and S12 are obtained by use of the one-shot method, the image represented by the image data based on the low-energy radiation stored on the stimulable phosphor sheet on the side closest to the subject of photographing is displayed on the monitor 4; and for cases in which the image data S11 and S12 are obtained by use of the two-shot method, the image represented by the image data based on the high-energy radiation, is displayed on the monitor 4.

On the other hand, for cases in which a temporal subtraction process is performed by the subtraction means 6, the subtraction image Ssub is generally displayed on the monitor 4 as a reference image in addition to the image represented by the most recent image data S12. However, for cases in which the diagnostic findings inputted to the input means 1 include “no disease” or “no change in progression”, the image represented by the subtraction image data Ssub contains only artifacts caused by the misalignment between structural positions, and contains no valid data that can be explained to the patient. Accordingly, in the case that the diagnostic findings include “no disease” or “no change in progression”, the switching means 8 obtains only the most recent image data 12 from the image database 7 and displays the image represented thereby on the monitor 4, without obtaining subtraction image data Ssub.

Next, the operation of the fourth embodiment will be explained. FIG. 8 is a flow chart showing the operation of the fourth embodiment. Note that here, it is assumed that each of subtraction image data Ssub 1 and Ssub 2 represent a bone tissue image and a soft tissue image, respectively, which have been obtained by the performance of an energy subtraction process by the subtraction means 6, and image data S11 and S12, are stored in the image data base 7.

First, the input of the command to obtain the image data S11 and S12, as well as the diagnostic findings are received by the input means 1 (step S31) The switching means 8 switches between the display and the non-display of reference images based on the inputted diagnostic findings 8 (i.e., a bone tissue image and a soft tissue image) (step S32) . If the diagnostic findings include “calcification”, for example, because only the bone tissue image is displayed on the monitor 4, only the subtraction image data Ssub 1 representing the bone tissue image is obtained from the image data base 7. Further, if the diagnostic findings contain something other than “calcification”, because both the bone tissue image and the soft tissue image are displayed on the monitor 4, the subtraction image data Ssub 1 and Ssub 2 representing both the bone tissue image and the soft tissue image, respectively, are obtained from the image data base 7. Then, the image represented by the image data S11 or the image data S12 is displayed on the monitor 4 along with a reference image (step S33), to be provided for use in the explanation of the diagnosis to the patient.

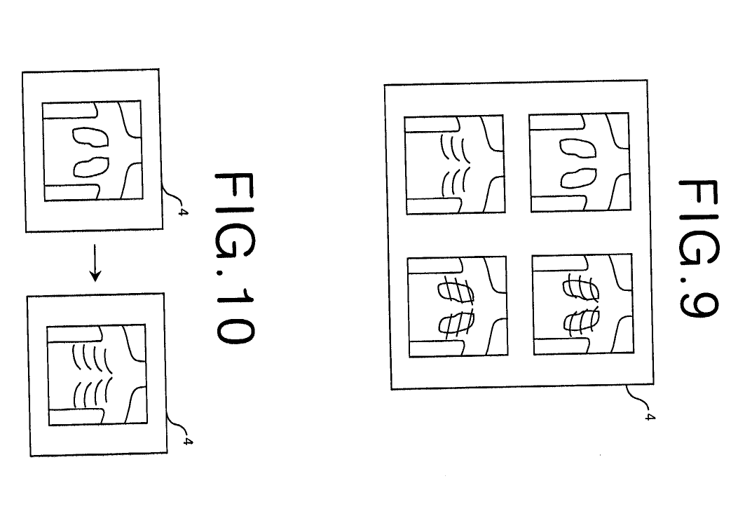

Note that the manner in which the monitor 4 displays the images may be that as shown in FIG. 9, where a plurality of images are displayed on one screen, or may be that as shown in FIG. 10, where the plurality of images are sequentially switched. Further, in the case that a plurality of monitors 4 are provided, each monitor 4 may display one image.

Note that according to the fourth embodiment, because switching between the display and non-display of at least one reference image relating to the image to be displayed corresponding to the diagnostic findings is performed, a reference image is displayed for cases in which the employment thereof facilitates ease in the explanation of the results of the diagnosis to the patient, and the explanation of the results of the diagnosis are explained to the patient easily. On the other hand, for cases in which the results of the diagnosis can be explained to the patient without the use of reference images, reference images are not displayed. Accordingly, an image can be displayed as a larger image on the monitor 4, and the trouble of switching among the display of a plurality of images on the display screen of the monitor 4, or the display of images on a plurality of monitors 4 can be saved.

Next, the fifth embodiment of the present invention will be explained. FIG. 11 is a block diagram of the fifth embodiment of the image display apparatus according to the present invention. Note that elements of the fifth embodiment shared in common with the first embodiment are likewise labeled, and in so far as it is not particularly required, further explanation thereof is omitted. The fifth embodiment differs from the first embodiment in that the fifth embodiment is provided with an image data base 17 for storing a plurality of image data Sn, and a layout means 9 for setting a plurality of display layouts, corresponding to the diagnostic findings inputted to the input means 1, when images represented by the plurality of image data Sn stored in the image data base 17 are to be displayed on the monitor 4.

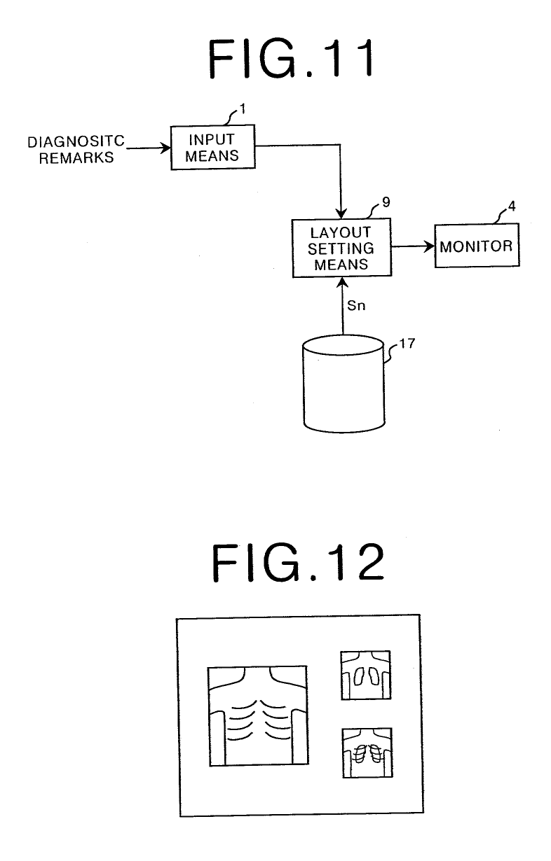

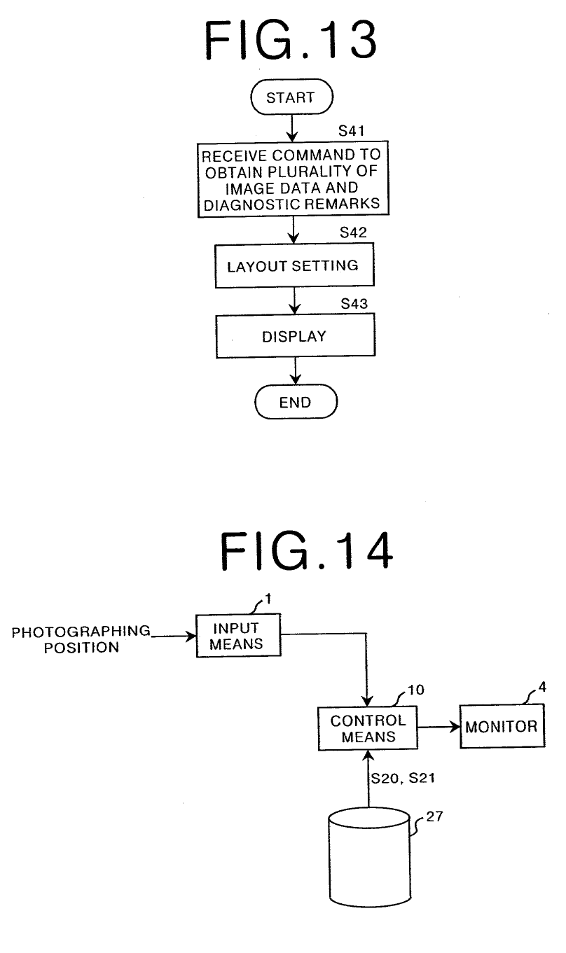

Here, the image that should be displayed on the monitor 4 is an image that has been obtained by use of the energy subtraction process explained above in the fourth embodiment, and for a case in which the diagnostic findings include “calcification”, the calcified portions can be easily recognized by observing the bone tissue image. Accordingly, if there are image data obtained by subjecting a plurality of image data Sn to a subtraction process, as well as the subtraction image data representing the bone tissue image and the soft tissue image, for cases in which the diagnostic findings include “calcification”, the layout means 9 sets the layout so that the bone tissue image is displayed largest, as shown in FIG. 12.

Next, the operation of the fifth embodiment will be explained. FIG. 8 is a flow chart showing the operation of the fifth embodiment. First, the input of a command to obtain a plurality of image data Sn as well as the diagnostic findings is received by the input means 1 (step S41) . The layout setting means 9 sets the layout of the plurality of image data Sn in accordance with the inputted diagnostic findings (step S42) .Then, the plurality of images represented by the plurality of image data Sn are displayed on the monitor 4 in the set layout (step S43), to be provided for use in the explanation of the diagnosis to the patient.

In this manner, according to the fifth embodiment, because the display layout is set according to the diagnostic findings, the results of the diagnosis can be explained to the patient easily.

Note that according to the fifth embodiment, although in the explanation provided above the display layout of a plurality of images represented by the plurality of image data Sn has been set according to the inputted diagnostic findings, the display order of the plurality of images represented by the plurality of image data Sn may be set.

Further, with regard to the third embodiment, for cases in which an enlargement process has been performed on the diagnostic region, the display layout of the enlargement image and the original image can be set. In this case, as to the display layout, the original image and the enlargement image can be arranged next to each other and displayed, or the display can be switched in order between each said image. Also, a layout may be adopted wherein unnecessary regions occurring within the pre-enlargement image (such as portions that have been directly irradiated by the radiation) are superimposed with the enlargement image and displayed.

Next, the sixth embodiment of the present invention will be explained. FIG. 14 is a block diagram of the sixth embodiment of the image display apparatus according to the present invention. Note that elements of the sixth embodiment shared in common with the first embodiment are likewise labeled, and in so far as it is not particularly required, further explanation thereof is omitted. The sixth embodiment differs from the first embodiment in that the sixth embodiment is provided with an image data base 27 for storing normal image data S21 representing a plurality of normal images corresponding to an image data S20 and various portions appearing therein, and a control means 10 for selecting from the image data base 27 a normal image data S21 representing the portions photographed in the image represented by the image data S20 in the non-diseased state when said image represented by the image data S20 is to be displayed on the monitor 4, and displaying the images represented by the image data S20 and S21 on the monitor 4. Note that the control means corresponds to a selecting means.

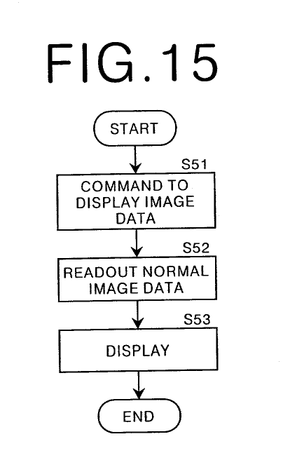

Next, the operation of the sixth embodiment will be explained. FIG. 15 is a flow chart showing the operation of the sixth embodiment. First, the input of a command to display the image represented by the image data S20, and the photographed portions are received by the input means 1 (step S51). Based on the data representing the inputted photographed portions, the control means 10 reads out from the image data base 27 the image data S20 and the normal image data S21 representing the normal image corresponding to the photographed portions within the image represented by said image data S20 (step S52) . Then, the images represented by the image data S20 and S21 are displayed on the monitor 4 (step S53), to be provided for use in the explanation of the diagnosis to the patient. Note that the image represented by the image data S20 and the image represented by the image data S21 can be arranged next to each other and displayed, or the display can be switched sequentially between each said image.

In this manner, according to the sixth embodiment, because an image containing abnormal portions and a normal image are displayed on the monitor 4, the patient can easily compare the normal and abnormal portions, and the physician can easily explain the results of the diagnosis to the patient.

What is claimed is:

1. An image display method comprising the steps of subjecting medical image data to an image process to obtain processed image data, and displaying the processed medical image represented by said processed image data on a monitor, wherein
input of medical explanatory data related to the medical image represented by the medical image data is received, and
said medical image data is subjected to an image process according to an image processing parameter corresponding to the medical explanatory data.

2. An image display method comprising the steps of subjecting medical image data to image processes to obtain processed image data, and displaying the processed medical image represented by said processed image data on a monitor, wherein
input of medical explanatory data related to the medical image represented by the medical image data is received, and
said medical image data is subjected to a plurality of types of image processes according to image processing parameters for a plurality of types of image processes corresponding to the medical explanatory data.

3. An image display method comprising the steps of subjecting medical image data to image processes to obtain processed image data, and displaying the processed medical image represented by said processed image data on a monitor, wherein
input of the diagnostic findings as well as the diagnostic region, of which the diagnostic findings obtained, within the medical image represented by the medical image data are received, and
the image processes are performed based on the region data and the diagnostic findings representing the diagnostic region.

4. An image display method comprising the step of displaying a medical image represented by medical image data on a monitor, wherein
input of medical explanatory data related to the medical image represented by the medical image data is received, and
the display or non-display of at least one reference image relating to said medical image, corresponding to said medical explanatory data and is switched between.

5. An image display method comprising the step of displaying a plurality of medical images represented by a plurality of medical image data on a monitor in a predetermined order and/or a predetermined layout, wherein
input of medical explanatory data related to the plurality of medical images is received; and
the predetermined order and/or the predetermined layout is set corresponding to said medical explanatory data.

6. An image display method comprising the step of displaying a medical image represented by medical image data on a monitor, wherein
based on the medical explanatory data related to the medical image, a normal image including the portions corresponding to the abnormal portions that are included within the medical image is selected from a storage means, which has recorded therein a plurality of normal images for a variety of portions, and
said corresponding normal image is displayed together with the medical image.

7. An image display apparatus for subjecting medical image data to an image process to obtain processed image data and displaying the processed medical image represented by said processed image data on a monitor, and which comprises
an input means that receives the input of medical explanatory data related to the medical image represented by the medical image data, and
an image processing means that subjects said medical image data to an image process according to an image processing parameter corresponding to the medical explanatory data.

8. An image display apparatus for subjecting medical image data to image processes to obtain processed image data and displaying the processed medical image represented by said processed image data on a monitor, and which comprises
an input means that receives the input of medical explanatory data related to the medical image represented by the medical image data, and
an image processing means that subjects said medical image data to a plurality of image processes according to image processing parameters for a plurality of image processes corresponding to the medical explanatory data.

9. An image display apparatus for subjecting medical image data to image processes to obtain processed image data and displaying the processed medical image represented by said processed image data on a monitor, and which comprises
an input means that receives the input of the diagnostic findings, as well as the diagnostic region of which the diagnostic findings have been obtained within the medical image represented by the medical image data, and
an image processing means that subjects, based on the region data as well as the diagnostic findings representing the

10. An image display apparatus for displaying a medical image represented by medical image data on a monitor, and which comprises
an input means that receives the input of medical explanatory data related to the medical image represented by the medical image data, and
an image switching means that switches between the display and non-display of at least one reference image relating to said medical image, corresponding to said medical explanatory data.

11. An image processing apparatus for displaying a plurality of medical images represented by a plurality of medical image data on a monitor in a predetermined order and/or a predetermined layout, and which comprises
an input means that receives input of medical explanatory data related to the plurality of medical images, and
a layout setting means that sets the predetermined order and/or the predetermined layout corresponding to said medical explanatory data.

12. An image display apparatus for displaying a medical image represented by medical image data on a monitor, and which comprises
a storage means that has recorded therein, based on the medical explanatory data related to the medical image, a plurality of normal images for various portions,
a selecting means that selects from the storage means a normal image including portions corresponding to the abnormal portions that are included within the medical image, and
a display means that displays said corresponding normal image together with the medical image.

13. A program for causing a computer to execute an image display method that subjects medical image data to an image process to obtain processed image data, and displays the processed medical image represented by said processed image data on a monitor, and which comprises the procedures of
receiving the input of medical explanatory data related to the medical image represented by the medical image data, and
subjecting said medical image data to an image process according to an image processing parameter corresponding to the medical explanatory data.

14. A program for causing a computer to execute an image display method that subjects medical image data to image processes to obtain processed image data, and displays the processed medical image represented by said processed image data on a monitor, and which comprises the procedures of
receiving the input of medical explanatory data related to the medical image represented by the medical image data, and
subjecting said medical image data to a plurality of image processes by use of an image processing parameter for a plurality of image processes corresponding to the medical explanatory data.

15. A program for causing a computer to execute an image display method that subjects medical image data to image processes to obtain processed image data, and displays the processed medical image represented by said processed image data on a monitor, and which comprises the procedures of
receiving the input of the diagnostic findings and the diagnostic region, of which the diagnostic findings have been obtained, within the medical image represented by the medical image data, and
subjecting, based on the region data and the diagnostic findings representing the diagnostic region, the medical image data to image processes.

16. A program for causing a computer to execute an image display method that displays a medical image represented by a medical image data on a monitor, and which comprises the procedures of
receiving the input of medical explanatory data related to the medical image represented by the medical image data, and
switching between the display and non-display of at least one reference image relating to said medical image, corresponding to said medical explanatory data.

17. A program for causing a computer to execute an image display method that displays a plurality of medical images represented by a plurality of medical image data on a monitor in a predetermined order and/or a predetermined layout, and which comprises the procedures of
receiving input of medical explanatory data related to the plurality of medical images, and
setting the predetermined order and/or a predetermined layout corresponding to said medical explanatory data.

18. A program for causing a computer to execute an image display method that displays a medical image represented by medical image data on a monitor, and which comprises the procedures of
selecting from a storage means, which has recorded therein a plurality of normal images for various portions, a normal image including portions corresponding to the abnormal portions that are included within the medical image based on the medical explanatory data related to the medical image, and
displaying said corresponding normal image together with the medical image.
